(19) United States
(12) Patent Application Publication
(10) Pub. No.: US 2024/0316801 A1
(43) Pub. Date: Sep. 26, 2024

(54) MULTI-BLADED KNIFE

(71) Applicant: Robert Jacob Berman, New York, NY (US)

(72) Inventor: Robert Jacob Berman, New York, NY (US)

(21) Appl. No.: 18/610,527

(22) Filed: Mar. 20, 2024

Related U.S. Application Data
(60) Provisional application No. 63/491,099, filed on Mar. 20, 2023.
(60) Provisional application No. 63/471,317, filed on Jun. 6, 2023.

(51) Int. Cl. B26B 3/04

(52) U.S. Cl. CPC B26B 3/04

(57) ABSTRACT

A new bread knife in accordance with the present invention has one knife handle connected to multiple knife blades through one or more bars arranged perpendicularly to the knife handle and blades. The blades are arranged in parallel with one another and in co-planar fashion to as to make contact with the bread at substantially the same time during use, enabling one to cut the bread into multiple slices or pieces through a single cutting motion. The bread knife preferably has 2-4 blades, and could have an even or uneven number of blades up to as many as 13 blades. Each blade is preferably made of metal and has a serrated or non-serrated edge, to allow cutting of the bread at different locations through a single either back-and-forth sawing motion or simply a pressing down motion.

### RELATED APPLICATIONS

This application claims priority to U.S. Provisional Patent Application No. 63/491,099 filed on Mar. 20, 2023, entitled “MULTI-BLADED KNIFE,” and U.S. Provisional Patent Application No. 63/471,317 filed on Jun. 16, 2023, entitled “MULTI-BLADED KNIFE,” the disclosures of which are hereby incorporated by reference in their entirety.

### BACKGROUND

Some families have many members and if they are all sitting down to a meal at the same time it will take time for the head of the household to cut a slice of bread for each member of the family.

For example, Orthodox Jews have a ritual meal every Friday night and Sabbath day at which the meal starts with eating challah bread. Jewish law requires the people who are partaking in the meal to ritually wash their hands before cutting and eating the challah bread. During that time period-from the washing of the hands to the eating of the challah bread—talking is forbidden. If there is a large family supping together with another large family, there is an uncomfortably long period of time where no one is allowed to talk because they are waiting and watching the head of the household cut bread for every single person partaking in the meal. Not only are all the people hungry but they are also uncomfortable in that they are not allowed to speak. Anything that can be done to reduce that time would be a welcome gastronomic and psychological relief.

Similarly, caterers and restaurants who are serving challah or other large breads need a way to cut many slices from the bread quickly to distribute to guests.

### SUMMARY OF INVENTION

A new bread knife in accordance with the present invention has one knife handle connected to multiple knife blades through one or more bars arranged perpendicularly to the knife handle and blades. The blades are arranged in parallel with one another and in co-planar fashion to as to make contact with the bread at substantially the same time during use, enabling one to cut the bread into multiple slices or pieces through a single cutting motion. The bread knife preferably has 2-4 blades, and could have an even or uneven number of blades up to as many as 13 blades. Each blade is preferably made of metal and has a serrated or non-serrated edge, to allow cutting of the bread at different locations through a single either back-and-forth sawing motion or simply a pressing down motion.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a perspective view of sample multi-bladed knife according to an embodiment of the invention.

### DETAILED DESCRIPTION OF EMBODIMENTS OF INVENTION

Subject matter will now be described more fully hereinafter with reference to the accompanying drawing, which forms a part hereof, and which shows, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

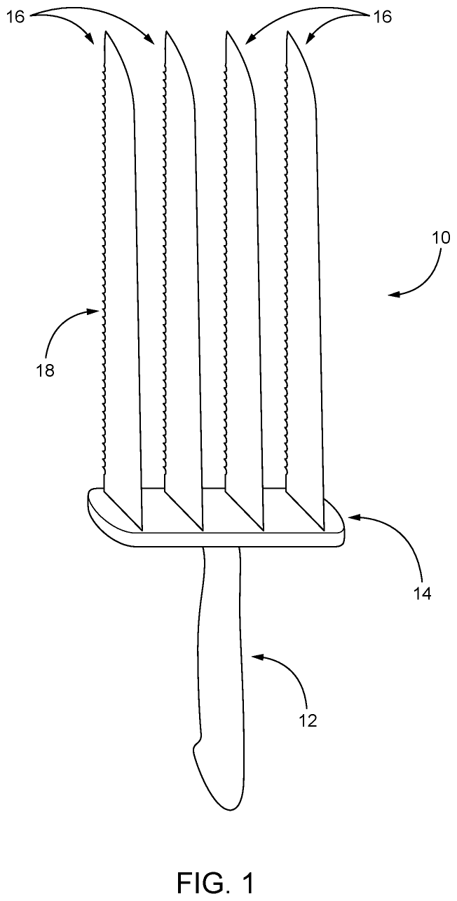

As illustrated in FIG. 1, a multi-bladed knife 10 in accordance with the present invention has a handle 12 connected to a horizontal bar 14 through a permanent affixing mechanism such as fasteners like nails or screws, glue, welding, or the like. Alternatively, the handle 12 and horizontal bar 14 may be one piece manufactured through a single mold. The horizontal bar 14 is in turn connected to two or more blades 16. FIG. 1 shows four such blades 16 but the knife 10 may have two or three blades 16 or more than four blades 16. The blades 16 are connected to horizontal bar 14 through a permanent affixing mechanism such as fasteners, glue or welding, or a temporary mechanism such as through grooves or slots in horizontal bar 14 sized to hold the base of blades 16.

In some embodiments the handle 12 is about 12 centimeters long and 2 centimeters thick and can be made of different materials such as but not limited to: wood, silver, porcelain, plastic, etc.

The horizontal bar 14 is perpendicular and attached to the handle 12 and made of the same material as the handle 12 or some other material. The horizontal bar 14 serves as the base to hold and anchor the multiple blades 16. The base 14 will hold between 2 to 6 blades 16 but could hold as many as 13 blades 16.

The blades 16 will preferably be made of metal, be serrated or non-serrated, and be about 20 centimeters long and about 2 millimeters thick. As shown in FIG. 1, the blades 16 on knife 10 of one embodiment has serrations 18. Although the blades 16 shown in FIG. 1 are all the same length and thickness, in other embodiments the blades 16 may vary in length and/or thickness from each other.

The distance between the blades 16 will range between about 2-5 centimeters. In some embodiments, the thickness of and distance between blades 16 is preferably inversely related to the number of blades 16 so that the more blades 16 used, the thinner and more closely spaced they are. In some embodiments the distance between blades may vary such that, for example, the distances between blades further from the center blade 16 or center of the horizontal bar 14 are shorter than the distances between blades 16 closer to such center.

In some embodiments, the blades 16 are connected to a laterally extending groove in the horizontal bar 14 so they can slide laterally along the bar from a fully closed position where the blades 16 are bunched together in the center of the bar for storage when not in use to a spread position in which they are spread apart for use during cutting as explained above. The groove may have locking mechanisms to lock the blades 16 at the preset locations.

In addition, in some embodiments the horizontal bar 14 may be connected to the handle 12 and/or blades 16 by hinges to allow for the compression of the bread knife 10 during storage.

FIG. 1 is a conceptual illustration allowing for an explanation of the disclosed embodiments of the invention. Notably, the FIGURE and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

1. A bread knife comprising a single blade handle connected to a plurality of metal knife blades arranged in parallel with one another, the knife blades being spaced apart from each other by a distance of approximately 2-5 centimeters, wherein the knife blades are positioned to make contact with bread simultaneously when used and to cut through the bread at different locations due to a sawing motion of the blade.

2. The bread knife of claim 1 wherein one or more of the knife blades has a serrated edge.

3. The bread knife of claim 1 wherein one or more of the knife blades has a non-serrated edge.

4. The bread knife of claim 1, wherein the bread knife comprises two blades.

5. The bread knife of claim 1, wherein the bread knife comprises three blades.

6. The bread knife of claim 5, wherein the blades are evenly spaced apart from each other.

7. The bread knife of claim 1, wherein the blades are connected to the blade handle through a bar connected to the handle and extending perpendicular to the handle and blades.

8. A knife comprising:
a handle;
a bar attached to the handle at the center of the bar and arranged perpendicularly to the handle; and
a plurality of blades connected to the bar and extending away from the handle, the blades being substantially equal in length and thickness and being spaced apart from each other or from the center of the bar substantially equally.

9. The knife of claim 8 wherein one or more of the blades has a serrated edge.

10. The knife of claim 8 wherein one or more of the blades has a non-serrated edge.

11. The knife of claim 8, wherein the bread knife comprises two blades.

12. The knife of claim 8, wherein the bread knife comprises three blades.

13. The knife of claim 12, wherein the blades are evenly spaced apart from each other.
